(19) United States
(12) Patent Application Publication
(10) Pub. No.: US 2016/0285136 A1
(43) Pub. Date: Sep. 29, 2016

(54) CONTROL SYSTEM FOR SECONDARY BATTERY

(71) Applicant: HITACHI, LTD., Tokyo (JP)

(72) Inventor: Makoto ABE, Tokyo (JP)

(73) Assignee: HITACHI, LTD., Tokyo (JP)

(21) Appl. No.: 15/075,484

(22) Filed: Mar. 21, 2016

(30) Foreign Application Priority Data
Mar. 23, 2015 (JP) 2015-058914

(51) Int. Cl. H01M 10/42; H01M 10/613; H01M 10/0525; H01M 10/48

(52) U.S. Cl. CPC H01M 10/4257; H01M 10/48; H01M 10/613; H01M 10/0525; H01M 2220/10; H01M 2220/20; H01M 2220/30

(57) ABSTRACT

The deterioration-progression determination circuit is configured to determine progression of deterioration of the secondary battery. The controller is configured to control at least upper limit temperature of the secondary battery. The control-value change determination unit is configured to control a change of the upper limit temperature, and configured to set the upper limit temperature of the secondary battery to equal to or more than an initial value based on a result of comparison between a deterioration level of the secondary battery and an estimated deterioration level.

### BACKGROUND OF THE INVENTION

1. Field of the Invention

The present invention relates to a control system of power storage using a secondary battery.

2. Description of the Related Art

A lithium ion secondary battery, which is a type of a non-aqueous electrolyte solution secondary battery, has significantly higher electromotive force (3V or more) than the electromotive force (about 1.5 V) of an aqueous electrolyte solution secondary battery (for example, nickel hydrogen battery, nickel cadmium cell, and lead-acid battery). Accordingly, the lithium ion secondary battery, which is advantageous to reduction in physical size and weight, larger in capacity, and higher-power of a battery, has been widely employed for small electronic equipment such as a portable computer and a mobile phone. In recent years, the lithium ion secondary battery has been more widely used for the purposes of a large-sized electric apparatus (for example, a power source for automobiles such as an hybrid electric vehicle (HEV) and an electric vehicle (EV), and a power supply for power storage).

It is important for a secondary battery employed for the power source for automobile to have a life-span approximately equivalent to a life-span of a vehicle, from maintenance and an initial cost perspective. From the above-described perspective, the battery is designed so as to have a storage capacity approximately equivalent to that of the life-span of the vehicle under such conditions as a driving history with the heaviest load is estimated. However, in most cases, a more moderate drive than the estimated driving history with the heaviest load is performed under actual usage conditions. There are many cases where the remaining service life is left in the secondary battery when the vehicle is at the end of its life. That is, this results in waste because the mounted secondary battery is no longer in use with its performance incapable of being fully exhibited. Meanwhile, the battery is at the end of its life before the end of vehicle life depending on the driving history when reducing the storage capacity so as to prevent a remaining life from being wasted. This causes increase of maintenance costs involving such as an emergency maintenance.

JP-2013-240236-A discloses that: a performance degradation permissible limit is calculated from an actual performance retention rate and a target performance retention rate of the secondary battery, appropriate temperature and center value of a charge rate State of Charge (SOC) based on the performance degradation permissible limit are determined, and accordingly controls in ways to prevent a suppression from being excessive are performed while suppressing deterioration of the battery. The technologies of changing a limiting degree corresponding to a deterioration degree are disclosed.

### SUMMARY OF THE INVENTION

The target performance retention rate of the battery is often set on the assumption of the driving history with the heaviest load for safety reasons. Accordingly, in most cases, the more moderate drive than the estimated driving history with the heaviest load is performed under actual usage conditions. There are many cases where the remaining service life is left in the secondary battery when the vehicle is at the end of its life. Therefore, not only the limiting and controls for suppression of the deterioration of the secondary battery but also an unlock control that increases an input and output power of the secondary battery are important in order to fully optimize a property of the secondary battery.

For the unlock control, the input and output power of the secondary battery may not be always increased depending on moderation of a control value. Making a wrong selection of a controllable factor may cause the battery to have safety issues.

It is a first object of the present invention to maximize performance of the secondary battery. To provide a control system for a secondary battery that is capable of balancing a life-span and safety defined by a decreasing rate of capacity at higher level.

The means for solving the problems of the present invention are as follows.

A secondary battery control system including: a secondary battery; a deterioration-progression determination circuit configured to determine progression of deterioration of the secondary battery; a controller configured to control at least upper limit temperature of the secondary battery; and a control-value change determination unit configured to control a change of the upper limit temperature, wherein the control-value change determination unit is configured to set the upper limit temperature of the secondary battery to equal to or more than an initial value based on a result of comparison between a deterioration level of the secondary battery and an estimated deterioration level.

More preferred means is as follows.

The secondary battery control system further including:

a deterioration-progression determination circuit configured to calculate an SOH of the secondary battery.

The secondary battery control system,

wherein the deterioration level is determined based on a remaining life of the secondary battery, and

the control-value change determination unit is configured to set the upper limit temperature of the secondary battery to equal to or more than the initial value based on the result of comparison between the remaining life of the secondary battery and an estimated remaining life.

The secondary battery control system,

wherein the control-value change determination unit includes

a predicted life-span calculating unit configured to predict the remaining life,

an estimated life-span storage unit configured to store the estimated remaining life previously stored, and

a comparison unit configured to compare the remaining life with the estimated remaining life and determine that the upper limit temperature of the secondary battery is to be set to equal to or more than the initial value when the remaining life exceeds the estimated remaining life.

The deterioration level may also be determined based on the SOH.

The secondary battery control system,

wherein the deterioration level is determined based on a SOH of the secondary battery, and

the control-value change determination unit is configured to set the upper limit temperature of the secondary battery to equal to or more than the initial value based on the result of comparison between the SOH of the secondary battery and an estimated SOH.

The secondary battery control system,

wherein the control-value change determination unit includes

an estimated SOH calculating unit configured to store or calculate the estimated SOH, and

a comparison unit configured to compare the SOH of the secondary battery with the estimated SOH and determine that the upper limit temperature of the secondary battery is to be set to equal to or more than the initial value when the SOH exceeds the estimated SOH.

It is preferable to change the upper limit temperature prior to or in parallel with when controlling an SOC limit value, a center SOC limit value, and an upper voltage limit value as a control value, as described below.

The secondary battery control system,

wherein the controller is configured to change at least any of an SOC limit value, a center SOC limit value, and an upper voltage limit value of the secondary battery based on the result of comparison between the deterioration level and the estimated deterioration level obtained by the deterioration-progression determination circuit, and

the upper limit temperature is changed prior to or in parallel with the SOC limit value, the center SOC limit value, and the upper voltage limit value.

According to the embodiment of the present invention, performance of the secondary battery can be maximized. The control system for the secondary battery capable of balancing a life-span and safety defined by a decreasing rate of capacity at higher level can be provided.

### BRIEF DESCRIPTION OF THE DRAWINGS

FIG. 1 illustrates a control system of a secondary battery according to a first embodiment of the present invention;

FIG. 2 illustrates a control system of a secondary battery according to a second embodiment of the present invention;

FIG. 3 illustrates a control system of a secondary battery in Comparative Example 1;

FIG. 4 illustrates a control system of a secondary battery in Comparative Example 2;

FIG. 5 illustrates a control system of a secondary battery in Comparative Example 3;

FIG. 6 illustrates a control system of a secondary battery according to a third embodiment of the present invention; and

FIG. 7 illustrates a control system of a secondary battery according to a fourth embodiment of the present invention.

### DESCRIPTION OF THE PREFERRED EMBODIMENTS

The embodiments of the present invention will be described in detail with reference to the accompanying drawings. They are intended to concretely illustrate, not to restrict, the scope of the present invention. They may be properly modified and changed by those who are skilled in the art within the technical idea disclosed herein.

### First Embodiment

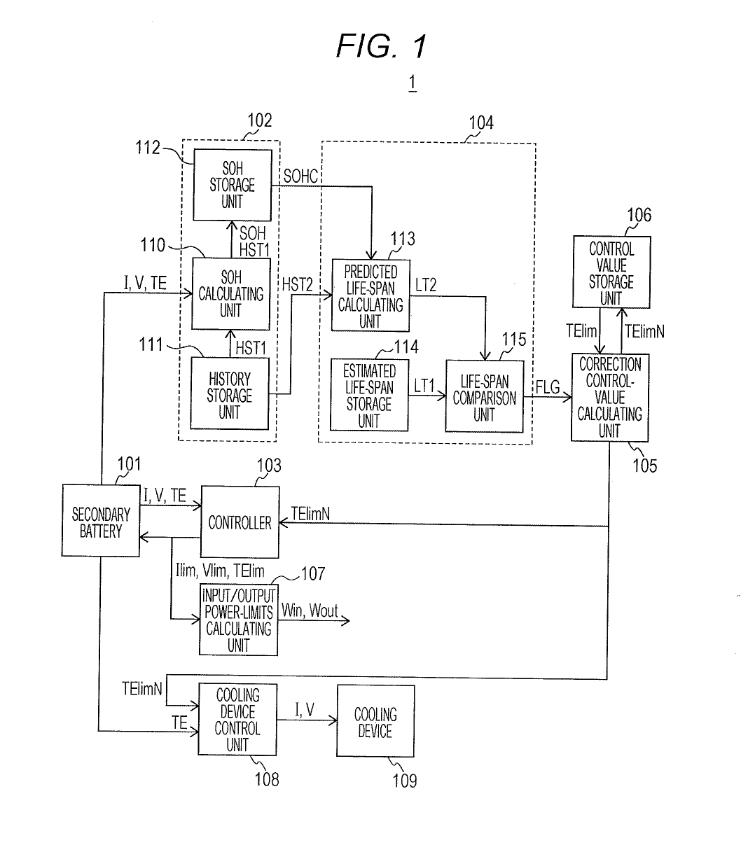

FIG. 1 is a block diagram of a battery system illustrating a first embodiment of a battery controller according to the present invention. The battery system of the first embodiment can be mounted in a hybrid vehicle such as a hybrid electric vehicle (HEV) and a plug-in hybrid electric vehicle (PHEV). A square in FIG. 1 denotes component for system construction. An arrow connecting one component to another denotes a transmission path of a signal. The transmitted signal is represented by a symbol adjacent to the arrow.

A control system for secondary battery 1 includes a secondary battery 101, a deterioration-progression determination circuit 102, a controller 103, a control-value change determination unit 104, a correction control-value calculating unit 105, a control value storage unit 106, an input/output power-limits calculating unit 107, a cooling device control unit 108, and a cooling device 109.

A lithium ion secondary battery can be employed as the secondary battery 101. For example, a module formed by laminating a plurality of the lithium ion secondary batteries is installed in the hybrid vehicle such as the HEV and the PHEV. The secondary battery 101 is controlled by a controller so as to operate with a current limiting Ilim, a voltage limiting Vlim, and a temperature limiting TElim. Such limitations are controlled by the controller 103. The current limiting as used herein is an upper limit of a current for definition of an input and output of the secondary battery 101. The voltage limiting Vlim includes an upper limit value VBmax and an lower limit value VBmin of a battery, an upper limit voltage VSOCmax and an lower limit voltage VSOCmin for definition of a State of Charge (SOC) range, and a voltage value VC for definition of a center SOC of a secondary battery.

The input/output power-limits calculating unit 107 is configured to calculate input/output limit values of Win and Wout of the secondary battery 101 based on the current limiting Ilim, the voltage limiting Vlim, and the temperature limiting TElim transmitted from the controller 103 and the secondary battery 101 to transmit to a higher order system. The higher order system determines an operation point of each system depending on input and output power to the battery based on the input/output limit values of Win and Wout of the secondary battery 101.

The deterioration-progression determination circuit 102 is configured to measure to calculate progression of deterioration of the secondary battery 101. The deterioration-progression determination circuit 102 includes a State of Health (SOH) calculating unit 110, a history storage unit 111, and an SOH storage unit 112. The history storage unit 111 is configured to store usage history of the secondary battery 101, and conditions for transmission of a history value HST1 to the SOH calculating unit 110 and transmission of a history value HST2 to a predicted life-span calculating unit. In the first embodiment, operating time of the secondary battery is stored in the history storage unit 111 as a history, and the condition for generating the history value HST1 is specified as a monthly basis. This ensures that each time the operating time of the secondary battery exceeds one month, the operating time at that time point is transmitted to the SOH calculating unit 110 of the secondary battery as the history value HST1.

The SOH calculating unit 110 is configured to calculate an SOH according to the timing of the HST1 being transmitted from the history storage unit. The SOH calculating unit 110 is configured to receive a current I, a voltage V, and a temperature TE from the secondary battery 101 to calculate a deterioration level SOH of the secondary battery 101. At least two items among the current I, the voltage V, and the temperature TE are needed for a calculation of the SOH. The SOH calculating unit 110 is configured to integrate a current value with the signal from the secondary battery 101 and calculate the present battery capacity using a collection of data indicating relationships among the calculated amount of charge and discharge, a change in voltage, the amount of charge and discharge before a use of the secondary battery, which is stored in the SOH calculating unit 110, and the voltage. The battery capacity is normalized with initial capacity of the battery stored in the SOH calculating unit to be converted into a capacity retention rate. The obtained capacity retention rate is transmitted to the SOH storage unit 112 as the SOH. Then, the history value HST1 is also transmitted. Other known methods can be used for calculation of the SOH from the current I, the voltage V, and the temperature TE. For example, the SOH is determined based on the capacity retention rate in the first embodiment. However, the SOH can be also determined based on such as a change in resistance and the change in voltage because the use of the secondary battery causes the change in resistance and the change in voltage.

The SOH calculated in the SOH calculating unit 110 in conjunction with the calculated timing, which includes a time axis and such as time and date from the start of using the secondary battery, are stored in the SOH storage unit 112.

As described above, the deterioration level (SOH) of the secondary battery 101 is obtained with the deterioration-progression determination circuit 102. The comparison of the deterioration level obtained by the deterioration-progression determination circuit 102 and an estimated deterioration level is performed in the control-value change determination unit 104. As the comparison result, an upper limit temperature of the secondary battery 101 can be raised when determined that the deterioration does not progress as much as estimated. When determined that the deterioration progresses, the upper limit temperature can be lowered and a property of the secondary battery can be limited. For the control of the first embodiment, besides the control of changing a limiting degree from an initial value of the upper limit temperature of the secondary battery in response to the progression of deterioration level, a value of the initial value or more of the upper limit temperature can be set and performance of the secondary battery can be positively unlocked when determined that the deterioration does not progress. Setting the value of the initial value or more of the upper limit temperature enables control capable of fully optimizing the most of the property of the secondary battery over the lifetime of a vehicle. When unlocking the performance of the secondary battery, a change of the upper limit temperature especially improves the property of the secondary battery effectively. The term “value of an initial value or more” indicates that it is possible to set to a value of a limit value or more set in early stages of using battery. For example, where the progression of deterioration is greater than expected and the limit value is set to be lower and then set to be higher again, the limit value may also not be set to a value exceeding the initial value. Setting to the value exceeding the initial value is preferred when positively unlocking battery performance.

The progression of deterioration level can be determined by, for example, the comparison of the SOH and an estimated SOH of the secondary battery (second embodiment). The progression of deterioration level can be determined by expecting an elapsed time from the SOH of the secondary battery to a time reaching the end of its lifetime and comparing this value with an estimated remaining life (first embodiment).

The control-value change determination unit 104 of the first embodiment includes a predicted life-span calculating unit 113, an estimated life-span storage unit 114, and a comparison unit (life-span comparison unit) 115.

The predicted life-span calculating unit 113 is configured to start processing upon receiving the history value HST2 from the history storage unit 111. Conditions for transmission of the history value HST2 may be identical to or different from the conditions for that of the history value HST1. For example, the condition for generating the HST1 can be specified as a monthly basis, and the condition for generating the HST2 can be specified as a bi-monthly basis. The history value HST1 needs to be transmitted to the SOH calculating unit at least one time while the history value HST2 is transmitted to the predicted life-span calculating unit twice, where the conditions for generating the HST1 and HST2 are different from each other.

The predicted life-span calculating unit 113 is configured to extract a collection of SOH data SOHC from the SOH storage unit 112 according to the timing of the history value HST2 being transmitted and predict a remaining life with those data (predicted life-span). The value of SOH determined as a secondary battery life-span is predetermined. The remaining time before reaching this value is calculated to be specified as the remaining life. The so-called root rule, which is commonly known as one example and shows that a linear relationship exists between the value of ½th power of an operation period and a capacity retention rate of a battery, is applied in the first embodiment and an elapsed time to a time reaching the end of lifetime is predicted.

The estimated life-span storage unit 114 is configured to store an estimated life-span LT1 of the secondary battery 101. The life-span comparison unit 115 is configured to start processing according to the timing of a predicted life-span LT2 being transmitted from the predicted life-span calculating unit. The life-span comparison unit 115 is configured to compare the predicted life-span LT2 with the estimated life-span LT1 received from the estimated life-span storage unit to determine whether to change a controllable factor of the secondary battery. The life-span comparison unit 115 is configured to give an instruction FLG for a change of the control value to the correction control-value calculating unit where the predicted life-span LT2 exceeds the estimated life-span LT1. Where the predicted life-span LT2 does not exceed the estimated life-span LT1, the life-span comparison unit 115 is configured to give an instruction FLG for not changing the control value.

The correction control-value calculating unit 105 is configured to extract the present temperature control value TElim from the control value storage unit 106 and calculate to determine the changed temperature control value TElimN where the signal received from the life-span comparison unit 115 is the instruction FLG for changing the control value. The correction control-value calculating unit 105 is configured to transmit the changed temperature control value TElimN, which is determined, to the control value storage unit 106 and the controller 103. The controller 103 is configured to rewrite the temperature control value TElim to the changed temperature control value TElimN to control the secondary battery upon receiving the changed temperature control value TElimN from the correction control-value calculating unit 105.

The calculation of the changed temperature control value TElimN performed by the correction control-value calculating unit 105 can employ an operation such as to increase the temperature of one degree per one FLG signal. The raised temperature can be changed appropriately.

The controller 103 is configured to control an upper limit voltage and an upper limit current other than the upper limit temperature. According to the present invention, a change of the upper limit temperature in the first place can effectively maximize performance of the secondary battery.

Where the controllable factor is changed so as to change the remaining life of the secondary battery to the battery performance, in the present invention, the controls are designed so that a battery capacity QB of the secondary battery is at least equal to or more than a value before change, and the input and output power limit values of Win and Wout to the secondary battery become equal to or more than a value before change. The battery capacity QB of the secondary battery 101 is determined based on the upper limit voltage VSOCmax for definition of the SOC range and the battery capacity defined in the range of the lower limit voltage VSOCmin. One input and output power limit values are expressed by the following expressions (1) and (2) using the battery voltage upper limit value VBmax, the battery voltage lower limit value VBmin, the present battery voltage, a battery input resistance Rchg, and a battery output resistance Rdis.

Win=(VBmax−Vcur)·VBmax/Rchg Expression (1)

Wout=(Vcur−VBmin)·VBmin/Rdis Expression (2)

In order to increase the input and output power limit values with the above expressions, there are four methods: VBmax<VBmaxN holds true between the upper limit voltage VBmax of the battery before change and the upper limit voltage value VBmaxN of the battery after change, VBmin>VBminN holds true between the lower limit voltage VBmin of the battery before change and the lower limit voltage value VBminN of the battery after change, Rchg>RchgN holds true between the input resistance Rchg of the battery before change and an input resistance value RchgN of the battery after change, and Rids<RdisN holds true between the output resistance Rdis of the battery before change and an output resistance value RdisN of the battery after change.

In accordance with the present invention, a lithium ion battery is applied as a secondary battery, of which its resistance has a negative coefficient with respect to a temperature. This ensures that an increase in temperatures of the respective input resistance Rchg and output resistance Rdis can satisfy the above-described conditions. The resistance has the negative coefficient with respect to the temperature, which causes a reduction of resistance due to a temperature rise. This results in an improvement of an input and output.

In the first embodiment, a mechanism that raises the temperature of the secondary battery by controlling a cooling device is included. The cooling device control unit 108 is configured to receive the changed temperature control value TElimN and the temperature TE of the secondary battery from the correction control-value calculating unit 105. The cooling device control unit 108 is configured to control the device so as to reduce a cooling performance where the temperature TE of the secondary battery is lower than the changed temperature control value TElimN. If the cooling device 109 is a fan, as an example, a reduction of a current I and a voltage V during operation of the fan decreases the number of rotations of the fan to reduce the cooling performance. It is also possible to positively raise the temperature of the secondary battery by stopping the operation of the fan where the temperature TE of the secondary battery is significantly lower than the changed temperature control value TElimN.

### Second Embodiment

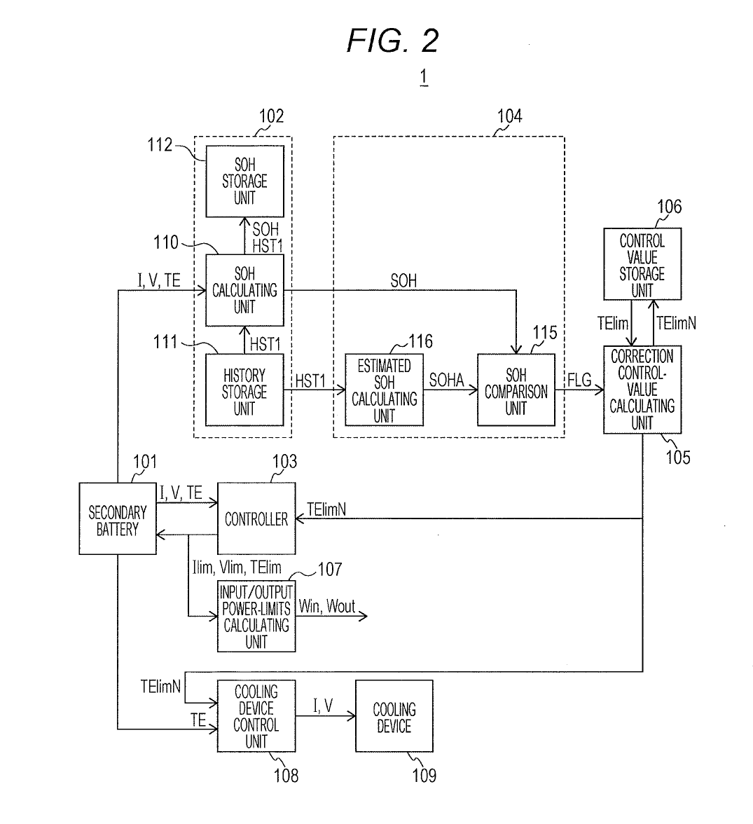

In a second embodiment illustrated in FIG. 2, the progression of deterioration level is determined by the comparison of the SOH and the estimated SOH of the secondary battery as described in the first embodiment.

The control-value change determination unit 104 of a third embodiment includes an estimated SOH calculating unit 116 and an SOH comparison unit 115 as a comparison unit. In the third embodiment, the comparison of the SOH and the estimated SOH of the secondary battery is performed for the progression of deterioration level. Consequently, the SOH of the secondary battery calculated in the SOH calculating unit 110 is transmitted to the SOH comparison unit as it is. The SOH calculated in the SOH calculating unit is compared with an estimated SOH value SOHA calculated in the estimated SOH calculating unit 116.

The estimated SOH calculating unit 116 is configured to start processing upon receiving the history value HST1 from the history storage unit. The estimated values of SOH for the operation period are previously stored as a collection of data in the estimated SOH calculating unit 116. The present SOH to be estimated is calculated using the collection of data and the history value HST1. Where no operation period transmitted as the history value HST1 exists in the collection of data in the estimated SOH calculating unit, the estimated SOH value SOHA is determined using two data with the HST1 and based on its interior division. The collection of data relating to the estimated values of SOH may be a function or a table formed. In the case of the function, the estimated SOH is calculated from the operating time of the secondary battery. In the case of the table, the estimated SOH corresponding to the operating time of the secondary battery is selected from numerical values that are previously stored.

The comparison unit 115 is configured to start processing according to the timing of the SOHA as the estimated SOH being transmitted from the estimated SOH calculating unit. The SOH comparison unit 115 is configured to compare the SOH at present transmitted from the SOH calculating unit 110 with the SOHA received from the estimated SOH calculating unit to determine whether to change the controllable factor of the secondary battery. The SOH comparison unit 115 is configured to give an instruction FLG for a change of the control value to the correction control-value calculating unit where the SOHA exceeds the SOH at present. Where the SOHA does not exceed the SOH at present, the SOH comparison unit 115 is configured to give an instruction FLG for not changing the control value.

The correction control-value calculating unit 105 is identical to those in the first embodiment. The correction control-value calculating unit 105 is configured to extract the present temperature control value TElim from the control value storage unit 106 to determine the changed temperature control value TElimN where the signal received from the SOH comparison unit 115 is the instruction FLG for changing the control value. The correction control-value calculating unit 105 is configured to transmit the changed temperature control value TElimN, which is determined, to the control value storage unit 106 and the controller 103. The controller 103 is configured to rewrite the temperature control value TElim to the changed temperature control value TElimN to control the secondary battery upon receiving the changed temperature control value TElimN from the correction control-value calculating unit 105.

The controller 103 is configured to control the upper limit voltage and the upper limit current other than the upper limit temperature. According to the present invention, a change of the upper limit temperature in the first place can effectively maximize performance of the secondary battery.

The third embodiment may also provide a mechanism that positively raises the temperature of the secondary battery by the controls performed in the second embodiment afterwards.

### COMPARATIVE EXAMPLE 1

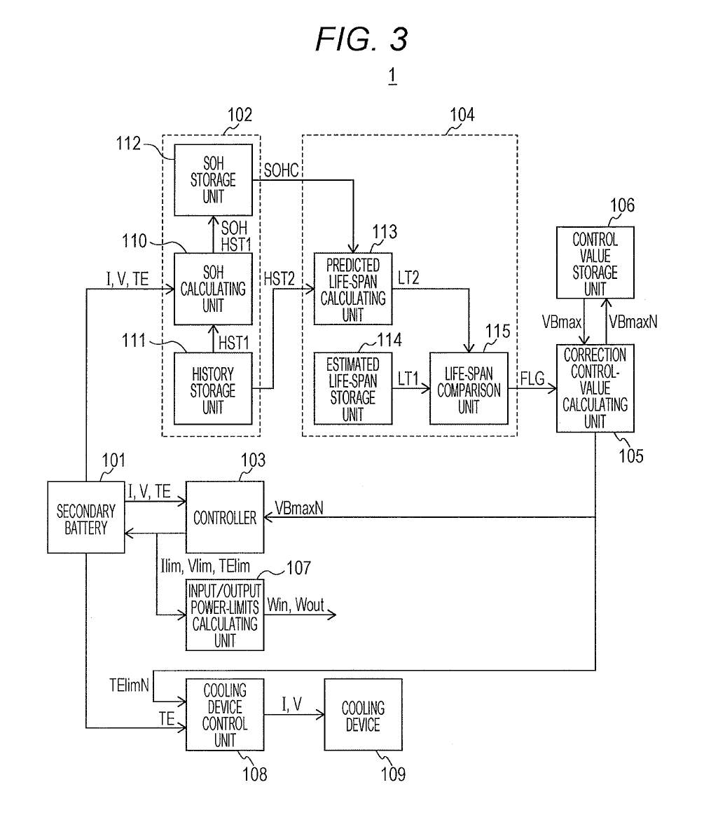

FIG. 3 is a block diagram of a battery system illustrating a configuration of Comparative Example 1.

While the upper limit temperature is changed corresponding to measurement results of the progression of deterioration level in the first embodiment, an upper limit voltage is changed in Comparative Example 1.

In Comparative Example 1, the control value storage unit 106 is configured to store the upper limit value VBmax and the lower limit value VBmin of the battery voltage. The correction control-value calculating unit 105 is configured to extract the present upper limit value VBmax and the lower limit value VBmin of the battery voltage from the control value storage unit 106 to determine the changed upper limit value VBmaxN and the lower limit value VBminN of the battery voltage. The correction control-value calculating unit 105 is configured to transmit the changed upper limit value VBmaxN and the lower limit value VBminN of the battery voltage, which are determined, to the control value storage unit and the controller. The controller is configured to rewrite the upper limit value VBmax and the lower limit value VBmin of the battery voltage to the changed upper limit value VBmaxN and the lower limit value VBminN of the battery voltage to control the secondary battery, upon receiving the changed upper limit value VBmaxN and the lower limit value VBminN of the battery voltage from the correction control-value calculating unit.

### COMPARATIVE EXAMPLE 2

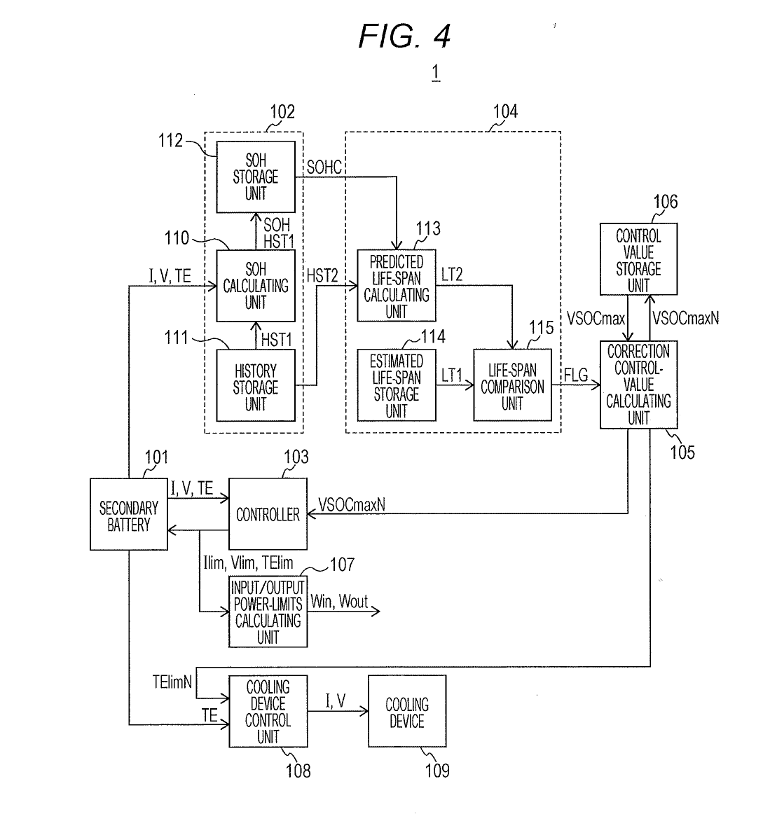

FIG. 4 is a block diagram of a battery system illustrating a configuration of Comparative Example 2. While the upper limit temperature is changed corresponding to measurement results of the progression of deterioration level in the first embodiment, an SOC range is changed in Comparative Example 2.

In Comparative Example 2, the control value storage unit 106 is configured to store the upper limit voltage VSOCmax and the lower limit voltage VSOCmin for definition of the SOC range. The SOC range is determined based on a voltage at the start and completion of charge. This ensures that a change of the upper limit voltage VSOCmax and the lower limit voltage VSOCmin can change the SOC range.

The correction control-value calculating unit is configured to extract the present upper limit voltage VSOCmax and the lower limit voltage VSOCmin for definition of the SOC range from the control value storage unit to determine the changed upper limit voltage VSOCmaxN and the lower limit voltage VSOCminN for definition of the SOC range. The correction control-value calculating unit is configured to transmit the changed upper limit voltage VSOCmaxN and the lower limit voltage VSOCminN for definition of the SOC range, which are determined, to the control value storage unit and the controller. The controller is configured to rewrite the upper limit voltage VSOCmax and the lower limit voltage VSOCmin for definition of the SOC range to the changed upper limit voltage VSOCmaxN and the lower limit voltage VSOCminN for definition of the SOC range to control the secondary battery, upon receiving the changed upper limit voltage VSOCmaxN and the lower limit voltage VSOCminN for definition of the SOC range from the correction control-value calculating unit.

### COMPARATIVE EXAMPLE 3

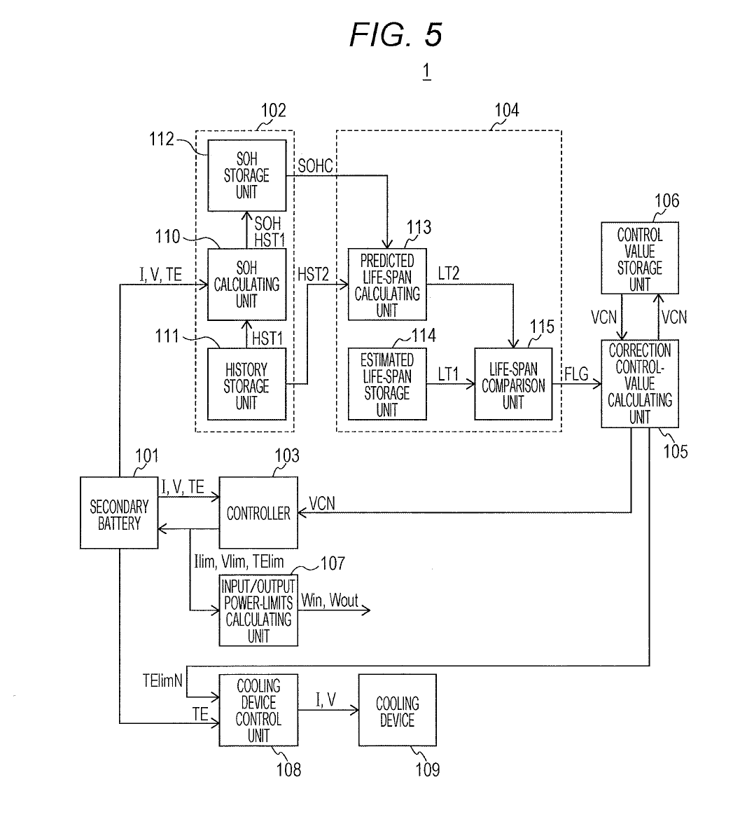

FIG. 5 is a block diagram of a battery system illustrating a configuration of Comparative Example 3.

In Comparative Example 3, control value storage unit 106 is configured to store a voltage value VC for definition of a center SOC. The correction control-value calculating unit 105 is configured to extract the present voltage value VC for definition of the center SOC from the control value storage unit 106 to determine the changed voltage value VCN for definition of the center SOC. The correction control-value calculating unit 105 is configured to transmit the changed voltage value VCN for definition of the center SOC of the secondary battery, which is determined, to the control value storage unit 106 and the controller 103. The controller 103 is configured to rewrite the voltage value VC for definition of the center SOC to the changed voltage value VCN for definition of the center SOC to control the secondary battery, upon receiving the changed voltage value VCN for definition of the center SOC from the correction control-value calculating unit 105.

### Third Embodiment

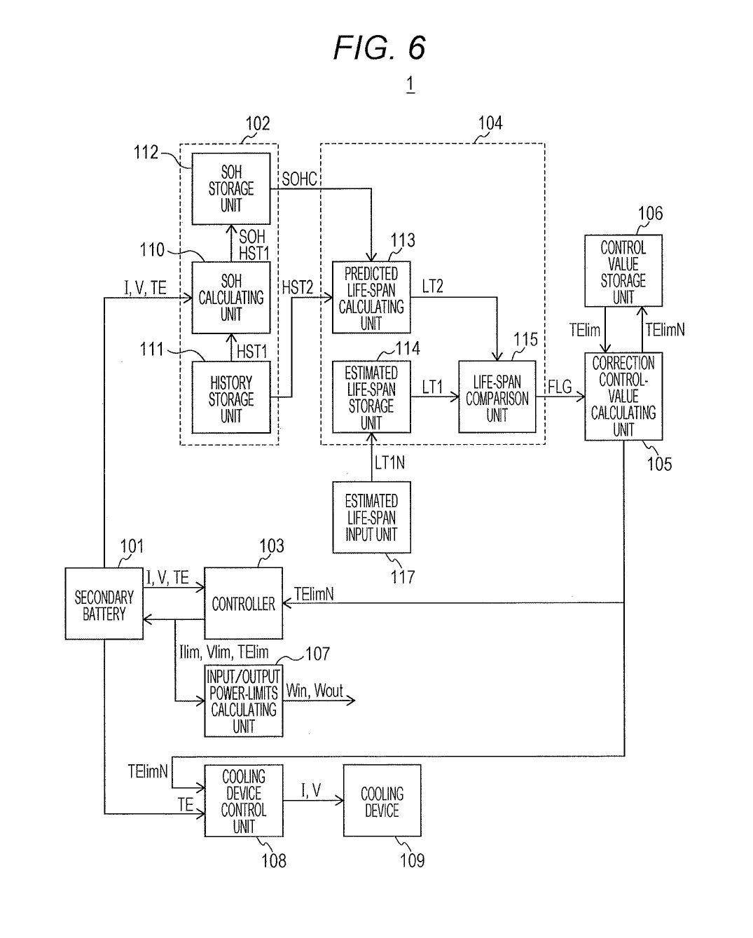

FIG. 6 is a block diagram of a battery system illustrating a configuration of a third embodiment. The third embodiment has a configuration in which an estimated life-span input unit is added to the first embodiment.

An estimated life-span input unit 117 includes a circuit for rewriting a value of estimated remaining life. For example, a user can input an estimated life-span value LT1N with a device for input of numerical values at the desired timing. The estimated life-span input unit 117 is configured to transmit the estimated life-span value LT1N inputted in the estimated life-span storage unit 114 when the estimated life-span is inputted. The estimated life-span storage unit 114 is configured to rewrite the estimated life-span LT1 internally stored to the LT1N upon receiving the LT1N. The estimated life-span input unit is configured to rewrite the estimated remaining life. However, in the case of the third embodiment, the estimated SOH may be rewritten.

The third embodiment can be used: to change a life-span estimated initially during system operation, for example, to stop the system operation in a shorter period of time, and to extend the period of system operation.

### Fourth Embodiment

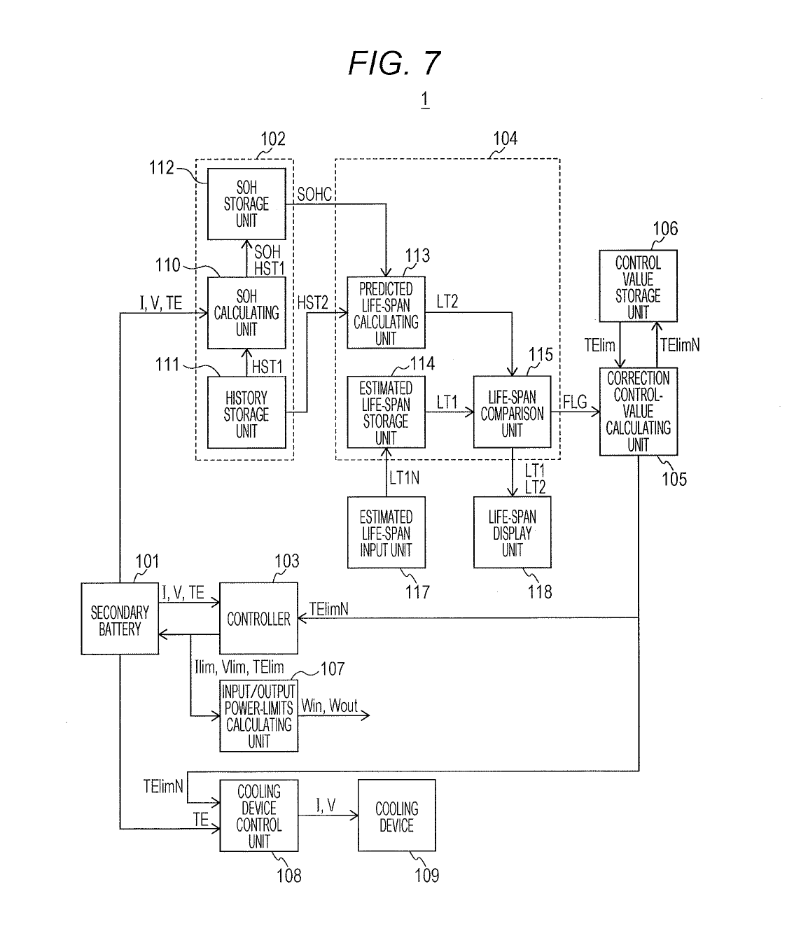

FIG. 7 illustrates a control system of a secondary battery according to a fourth embodiment of the present invention. The fourth embodiment has a configuration in which a life-span display unit 118 is added to the third embodiment. The life-span display unit 118 is configured to display the estimated life-span LT1 and the predicted life-span LT2 that are transmitted from the life-span comparison unit 115.

An estimated life-span input unit 117 and the life-span display unit 118 of the third and the fourth embodiments can be applied to the other embodiments.

The only temperature as the limit value is changed in the first to fourth embodiments. However, the voltage limit value, the SOC limit value, and the center SOC limit value may be changed in a manner such as Comparative Examples 1 to 3 in conjunction with the temperature. In this case, it is important to first raise the upper limit temperature in preference to these limit values. Alternatively, the limit values may be changed at the same time.

The comparison results of the battery capacity QB, the input/output limit values of Win and Wout, and a safety level of the battery after change of the control value in the battery before rewriting the control value, the first to fourth embodiments, and Comparative Examples 1 to 3 are summarized in Table 1.

The input/output limit values of Win and Wout constantly changes corresponding to a state of the SOC of the battery. Accordingly, the maximum value and the minimum value of the available input/output limit values within the estimated SOC range are given in Table 1. The battery capacity QB and the input/output limit values of Win and Wout are expressed in a ratio of which the value before change of the control value is set to a base value of 100. The safety level is classified as Equivalent or Lower compared with a condition before change of the control value. The safety level is determined with the voltage upper and lower limit values of the secondary battery. The lithium ion battery generally operates in a range of from about 3V for the lower limit value VBmin to about 4V for the upper limit value VBmax. This setting is done for a guarantee of the safety of the lithium ion battery.

It is known that an increase of the voltage upper limit of the secondary battery or a decrease of the voltage lower limit of the secondary battery results in the increase of the input/output limit value though the decrease of safety.

The increase of the voltage upper limit of the secondary battery causes the battery to be overcharged, which increases the risk of burns and explosions. More specifically, the increase of the voltage of the battery promotes an oxidative decomposition reaction of an electrolytic solution in the lithium ion battery. The oxidative decomposition reaction occurs with heat. Consequently, the temperature of the battery rises suddenly and the oxidative decomposition reaction is further accelerated. A repetition of the decrease causes an increase of internal pressure and the risk of the explosion of the battery.

Meanwhile, the decrease of the voltage lower limit of the secondary battery causes the battery to be overdischarged, which increases the risk of an internal short circuit. More specifically, the decrease of the voltage of the secondary battery causes an increase of negative electrode potential and an elution of foil used as a negative electrode. The eluted foil passes a gap of a separator as an insulating layer to reach a positive electrode side, which causes a short circuit and the risk of the explosion of the battery.

In the first to fourth embodiments in which the upper limit temperature as the control value is changed, the battery capacity QB and the input/output limit value increase. For the safety level, the result equivalent to the level before change is obtained. It has been observed that a rise of the temperature upper limit value enables a flow of a larger current and accordingly the input/output limit value increases. The rise of the temperature upper limit value causes a reduction of the input/output resistance and a reduction of overvoltage. This results in an increase of the capacity.

In contrast, in Comparative Example 1 in which the upper limit voltage is changed, the all values of the battery capacity QB and the input/output limit values of Win and Wout are 100 or more. However, an issue of the decrease of safety is raised. This is caused by an increase of the possibility for the battery to be overcharged and overdischarged by changing the upper and lower limit voltage of the battery.

In Comparative Example 2 in which the SOC range as the limit value is changed, the capacity increases by the amount of SOC range expansion. However, the cases in which the value is lower than the input/output limit value before rewriting the control values depending on a state of the SOC of the battery are observed. The SOC state of the battery as used herein is the case where the value of (VBmax−Vcur) or the value of (Vcur−VBmin), which is expressed by the expressions (1) and (2), decreases compared with the value before rewriting the control value. This is obviously inappropriate case for the object of the present invention, because the performance of the battery capacity QB doubled in size cannot be fully exhibited and the case in which the value is lower than the input/output limit before change of the control values depending on the condition is observed.

In Comparative Example 3 in which the center SOC as the limit value is changed, while the min and max values of the output limit Wout are both greater than 100, the min and max values of the input limit Win are both less than 100. This is obviously inappropriate case for the object of the invention, because a reduction of receiving performance causes a decrease of an accumulated amount of energy while the energy effectively accumulated can be discharged in an output side. This results from that (Vcur−VBmin) of the expression (2) increases and (VBmax−Vcur) of the expression (1) decreases by changing the center SOC.

The value itself fluctuates based on the rewritten value. However, there is no difference between tendencies in Comparative Examples 1-3 as shown above. Therefore, there are issues that remain even if any conditions are set in Comparative Examples 1-3.

The above-described results show that it is possible to maximize performance of the secondary battery and balance the life-span and the safety at higher level which are defined by a decreasing rate of the capacity by raising the temperature limiting to the initial value or more corresponding to the progression of deterioration of the battery.

TABLE 1

| | Control | | | | | | |
|---|---|---|---|---|---|---|---|
| | value to be | Battery | Win | | Wout | | Safety |
| | changed | capacity | min | max | min | max | level |
| Control value | None | 100 | 100 | 100 | 100 | 100 | — |
| before rewrite | | | | | | | |
| Embodiments | TElim | 101 | 103 | 104 | 103 | 104 | Equivalent |
| 1 to 4 | | | | | | | |
| Comparative | Vmax/min | 100 | 101 | 101 | 102 | 102 | Lower |
| Example 1 | | | | | | | |
| Comparative | VSOCmax/min | 200 | 80 | 106 | 89 | 107 | Equivalent |
| Example 2 | | | | | | | |
| Comparative | VC | 100 | 80 | 94 | 107 | 109 | Equivalent |
| Example 3 | | | | | | | |

What is claimed is:

1. A secondary battery control system comprising:
a secondary battery;
a deterioration-progression determination circuit configured to determine progression of deterioration of the secondary battery;
a controller configured to control at least upper limit temperature of the secondary battery; and
a control-value change determination unit configured to control a change of the upper limit temperature,
wherein the control-value change determination unit is configured to set the upper limit temperature of the secondary battery to equal to or more than an initial value based on a result of comparison between a deterioration level of the secondary battery and an estimated deterioration level.

2. The secondary battery control system according to claim 1, further comprising:
a deterioration-progression determination circuit configured to calculate an SOH of the secondary battery.

3. The secondary battery control system according to claim 2,
wherein the deterioration level is determined based on a remaining life of the secondary battery, and
the control-value change determination unit is configured to set the upper limit temperature of the secondary battery to equal to or more than the initial value based on the result of comparison between the remaining life of the secondary battery and an estimated remaining life.

4. The secondary battery control system according to claim 3,
wherein the control-value change determination unit comprises
a predicted life-span calculating unit configured to predict the remaining life,
an estimated life-span storage unit configured to store the estimated remaining life previously stored, and
a comparison unit configured to compare the remaining life with the estimated remaining life and determine that the upper limit temperature of the secondary battery is to be set to equal to or more than the initial value when the remaining life exceeds the estimated remaining life.

5. The secondary battery control system according to claim 2,
wherein the deterioration level is determined based on a SOH of the secondary battery, and
the control-value change determination unit is configured to set the upper limit temperature of the secondary battery to equal to or more than the initial value based on the result of comparison between the SOH of the secondary battery and an estimated SOH.

6. The secondary battery control system according to claim 5,
wherein the control-value change determination unit comprises
an estimated SOH calculating unit configured to store or calculate the estimated SOH, and
a comparison unit configured to compare the SOH of the secondary battery with the estimated SOH and determine that the upper limit temperature of the secondary battery is to be set to equal to or more than the initial value when the SOH exceeds the estimated SOH.

7. The secondary battery control system according to claim 4,
wherein the comparison unit is configured to transmit the result of a determination that the upper limit temperature of the secondary battery is to be set to equal to or more than the initial value to a correction control-value calculating unit, and
wherein the correction control-value calculating unit is configured to calculate a temperature to be raised and transmit the calculated result to the controller.

8. The secondary battery control system according to claim 1,
wherein the controller is configured to change at least any of an SOC limit value, a center SOC limit value, and an upper voltage limit value of the secondary battery based on the result of comparison between the deterioration level and the estimated deterioration level obtained by the deterioration-progression determination circuit, and
the upper limit temperature is changed prior to or in parallel with the SOC limit value, the center SOC limit value, and the upper voltage limit value.

9. The secondary battery control system according to claim 2, further comprising:
a cooling device control unit configured to change a degree of cooling of the secondary battery based on the result of the determination that the upper limit temperature of the secondary battery is to be set to equal to or more than the initial value.

10. The secondary battery control system according to claim 4, further comprising:
an estimated life-span input unit configured to rewrite a value of the estimated remaining life.

11. The secondary battery control system according to claim 4, further comprising:
a life-span display unit configured to display the estimated remaining life and a predicted remaining life that are transmitted from the comparison unit.
